(19) United States
(12) Patent Application Publication
(10) Pub. No.: US 2014/0027384 A1
(43) Pub. Date: Jan. 30, 2014

(54) Apparatus and Methods for Controlled Release of Additive Compositions

(71) Applicants: David Alan Little, Newtown, PA (US); Magesh Sundaram, Chicago, IL (US)

(72) Inventors: David Alan Little, Newtown, PA (US); Magesh Sundaram, Chicago, IL (US)

(73) Assignee: DOBER CHEMICAL CORPORATION, Woodridge, IL (US)

(21) Appl. No.: 13/804,468

(22) Filed: Mar. 14, 2013

Related U.S. Application Data
(60) Provisional application No. 61/676,541, filed on Jul. 27, 2012.

(51) Int. Cl. C02F 1/68

(52) U.S. Cl. CPC C02F 1/685
USPC 210/696; 210/205; 210/136; 210/749; 210/702

(57) ABSTRACT

Containers for controlled release of an additive composition into a liquid composition include a liquid impermeable casing having a hollow interior, at least one first opening, at least one second opening and at least one third opening, a liquid valve operable to allow a liquid composition to pass into the hollow interior across the liquid valve, an air valve operable to allow air to pass out of the hollow interior across the air valve and a membrane component secured to the casing. Methods of releasing additive compositions into liquid compositions are also provided.

### CROSS-REFERENCE TO RELATED APPLICATIONS

The present application claims the benefit of Provisional Application Ser. No. 61/676,541, filed Jul. 27, 2012, which claims the benefit of Provisional Application Ser. No. 61/642,000, filed May 3, 2012, which is a continuation-in-part of application Ser. No. 12/455,040, filed May 26, 2009, which is a continuation-in-part of application Ser. No. 12/154,898, filed May 27, 2008, now abandoned, and the present application claims priority to application Ser. No. 12/154,899, filed May 27, 2008, and claims the benefit of U.S. Provisional Application Ser. Nos. 61/163,796 filed Mar. 26, 2009, the disclosures of each of these applications being incorporated in their entirety herein by reference.

### FIELD OF THE INVENTION

The present invention relates to devices and methods for providing additive compositions comprising a chemical additive component to liquid compositions, such as industrial liquid compositions in cooling systems, for example, but not limited to, open circulating cooling or coolant systems, such as cooling towers and the like, humidification systems, recirculated spray water systems, fire quench tanks, fuel storage tanks, and the like.

### BACKGROUND OF THE INVENTION

Liquids in various systems are plagued by the buildup of scale and/or corrosion and/or one or more other contaminant materials often due to thermal and/or otherwise caused breakdown of dissolved components and assault of dissolved electrolytes on surfaces, for example, metal surfaces, of the system and/or one or more other environmental conditions. In an effort to mitigate this buildup/contamination, various chemical additives typically are added periodically to such systems, e.g., whenever liquid is added to the system. The chemical additives include, but are not limited to, anti-foulants, anti-scaling agents, corrosion inhibitors, pH buffering agents, microbiocides, and the like. Usually, the concentration of a particular agent in the system, for example, a cooling system, which may vary due to evaporation, chemical neutralization, and degradation, etc., is not known at any given time. Instead, a predefined amount of additives in a predetermined ratio is added to the system at regular maintenance intervals or whenever liquid levels drop to a level requiring additional liquid.

Various methods of introducing additives to fluid or liquid systems, generally, have been proposed. Rohde U.S. Pat. No. 3,749,247 describes a container for releasing an oxidation inhibitor into hydrocarbon-based lubricating oil in a working engine. The oxidation inhibitor is held in a polyolefin container that permits the additive to permeate through the container wall into the oil. A further approach is described by Lefebvre U.S. Pat. No. 5,591,330, which discloses a hydrocarbon oil filter wherein oxidation additives in a thermoplastic material are mounted in a casing between a particle filtering material and a felt pad. Reportedly, the thermoplastic material dissolves in the presence of high temperature oil thereby releasing the additives. Additionally, an additive release device for use in an engine hydrocarbon fuel line is proposed by Thunker et al U.S. Pat. No. 5,456,217. The latter device comprises a partially permeable cartridge positioned in the filling neck of the fuel tank so that whenever fuel is added a portion of the additive contents of the cartridge is released into the tank.

Aqueous-based liquids present an environment distinct from those of hydrocarbon fluids. For instance, most thermoplastics do not dissolve in aqueous solutions. Moreover, relatively large quantities of additives need to be provided in a typical industrial liquid, e.g., aqueous liquid, such as an industrial liquid used outside an engine or engine cooling system. Sudden provision of such large amounts of additives can cause a “slug” of material to precipitate and circulate in the system, which can result in damage and failure of pump seals. It would be advantageous to provide relatively low cost, quickly installed apparatus and methods that release additive compositions comprising chemical additives into liquid compositions, such as industrial liquid compositions at sustained rates to allow such compositions to function effectively without becoming unduly contaminated or otherwise being detrimentally affected by the additive compositions.

### SUMMARY OF THE INVENTION

New apparatus and methods for providing release, for example, effective and/or sustained and/or controlled release, of additive compositions comprising a chemical additive component into a liquid composition have been discovered. The present apparatus and methods effectively provide for release of additive compositions from the apparatus into liquid compositions, for example, aqueous liquid compositions, e.g., liquid compositions comprising water and at least one freezing point depressant, such as at least one glycol, non-aqueous liquid compositions, and the like. Advantageously, the additive composition is released only through a limited portion of the apparatus, for example, over either a relatively short period of time or a relatively prolonged period of time. The present apparatus and methods have been found to be highly effective and convenient in providing and controlling the effective release of additive compositions into liquid compositions.

The present apparatus are easy and straightforward to manufacture cost effectively and may easily and effectively be used in a relatively wide variety of systems/applications with little or no modification to effectively control the release of the additive composition into the liquid composition and/or the quality of the liquid composition.

In one broad aspect of the present invention, containers for releasing an additive composition into a liquid composition comprise a casing, an additive composition, at least one liquid permeable element, a liquid valve and an air valve.

In one example, the casing, for example, separate and apart from an engine, such as an internal combustion engine, filter housing, is impermeable to a liquid composition that is to be treated using the container. The casing defines a substantially hollow interior and at least one first opening into the hollow interior, at least one second opening into the hollow interior and at least one third opening into the hollow interior.

The additive composition comprises a chemical additive component provided or located in the hollow interior of the casing. In one example, the additive composition comprises an active component selected from the group consisting of corrosion inhibitors (corrosion control components), microbiocides, scale inhibitors (anti-scale components), dispersants, buffering agents, surfactants, anti-fouling agents, mixtures thereof and the like. The additive composition may be provided in the form of a liquid, gel, paste, or in solid form. In one example, the additive composition is provided as a plurality of particles, or in particulate form, for example, in the form of beads, tablets, pellets, grains, other particulate forms and mixtures thereof.

The at least one liquid-permeable element may be provided at or near the at least one first opening of the casing. This liquid-permeable element, for example and without limitation, comprising a membrane or membrane component, for example, a control membrane or control membrane component, is effective to provide for release, for example, effective and/or sustained and/or controlled release, of substantially all or a portion of the additive composition in the casing into a liquid composition, for example, a liquid composition in contact with, for example, external from, the casing. Such release may occur so that substantially all of the additive composition is released from the container into a liquid composition or may occur over a period of time so that a portion of the additive composition is retained within the casing. The release may occur at a sustained rate or even a substantially constant rate, for example, at least after the initial release of additive composition occurs. The additive composition release obtained in accordance with the present invention may involve diffusion of the additive composition into the liquid composition, and preferably is effective and/or sustained and/or controlled additive composition release.

The liquid valve may be operatively coupled to the at least one second opening and may be operable or operates, for example, automatically operates, such as operates without human intervention, to allow a liquid composition to pass into the hollow interior across the liquid valve. The liquid valve may operate to substantially prevent material, such as a liquid composition, or air, or other gas, from passing out of the hollow interior across the liquid valve. The liquid valve may be operable, or may operate, to substantially prevent air or other gas from passing into or out of the hollow interior across the liquid valve.

The air valve, which may be structured differently from or similarly to the liquid valve, may be operatively coupled to the at least one third opening and is operable or operates, for example, automatically operates, such as operates without human intervention, to allow air or other gas to pass out of the hollow interior across the air valve. The air valve may operate to substantially prevent any material, such as a liquid composition, air, or other gas, from passing into the hollow interior across the air valve. The air valve may be operable, or may operate, to substantially prevent a liquid composition from passing into or out of the hollow interior across the air valve. The air valve may be considered to be a gas valve.

In one example, the casing is structured to be not reusable, e.g., to be discarded or disposed of after a single use. For example, the casing may be structured so as not to be refillable with additive composition. Providing a “single use” container, that is a container having a non-reusable casing, may avoid direct human contact with additive compositions or additive components which may be toxic to humans or otherwise dangerous to handle by humans. During initial mass production manufacture of the present containers, safeguards may be provided to avoid substantial direct human contact with the additive compositions used to fill the casings. Such safeguards are often not available when refilling a single casing or a small number of casings with additive composition. Therefore, for example, in order to promote user safety and/or to provide containers of high and consistent quality, the present containers may be structured for one-time use, for example, so that they cannot be refilled with additive composition and/or otherwise reused.

In one example, the components, for example, the valves, of the present containers are relatively inexpensive compared to components which perform similar functions in prior containers. Therefore, the present containers may be advantageously (cost effectively) employed in one-time or single use applications compared to other containers which employ a single, more expensive valve, for example, a ball valve, to control the flow of liquid into the container and the flow of air out of the container.

In one example, the liquid valve is operable or operates to allow a liquid composition to pass, for example, rapidly flow, into the hollow interior, for example, through the at least one second opening, across the liquid valve, and to substantially prevent air from passing out of the hollow interior across the liquid valve. Such liquid valve, for example and without limitation, comprising a duckbill valve, an umbrella valve and the like valve, facilitates effective contact between the additive composition in the casing and a liquid, for example and without limitation, the liquid composition being treated.

In certain instances, for example, when the hollow interior of the casing includes certain additive compositions, rapid introduction of liquid into the hollow interior, across the liquid valve, may be advantageous to facilitate the release of the additive composition through the at least one liquid permeable element into the liquid composition external from the casing. Without wishing to limit the invention to any particular theory of operation, it is believed that the initial rate of liquid composition passing into the hollow interior through the at least one first opening and the at least one liquid permeable element may be relatively low. If the sole source of liquid composition to the hollow interior is through the liquid permeable member, the additive composition may form a thick paste or paste-like substance with this liquid composition to a sufficient extent to substantially block, e.g., to substantially inhibit or even substantially prevent, liquid composition from entering or exiting the hollow interior through the liquid permeable element. This substantial blocking of the liquid composition may render the present container inoperable.

The addition, for example, relatively rapid addition, of the liquid composition into the hollow interior of the container through the at least one second opening and across the liquid valve, for example, at a flowrate greater than the flowrate of the liquid composition through the at least one first opening across the at least one liquid permeable element, may reduce or even substantially eliminate blocking of the liquid composition from entering and/or exiting the hollow interior through the liquid permeable element relative to an identical container without the at least one second opening and the liquid valve. The at least one second opening may be a single second opening or a plurality of second openings.

In one example, the addition of the liquid composition through the at least one second opening and across the liquid valve is effective to facilitate the release of the additive composition from the hollow interior across the at least one liquid permeable element and through the at least one first opening into the liquid composition external from the casing.

In one example, air valve is provided operatively coupled to the at least one third opening and is operable or operates to allow air to pass out of the hollow interior through the at least one third opening. The at least one third opening may be a single opening or a plurality of openings. The air valve may be structured to substantially prevent a liquid composition from passing out of the hollow interior across the air valve and through the at least one third opening. The air valve, for example, comprising an umbrella valve, a duckbill valve, and the like valve, may facilitate effective contact between the additive composition and the liquid composition in the casing.

In one example, the liquid valve and the air valve are structured and effective to allow the liquid composition and additive composition to exit the hollow interior of the casing through the at least one first opening, while substantially preventing such release through the at least one second opening or the at least one third opening.

In one example, the air valve is structured and effective to substantially prevent liquid composition in contact with the casing from entering the hollow interior through the at least one third opening.

Each of the liquid valve and the air valve may operate or function separately and independently of the other valve. Accordingly, each of these valves may be independently controlled, manipulated and/or fine-tuned as desired. The valves may be relatively inexpensive and may be independently removably coupled to the casing, and may therefore be independently replaced, for example, when one of them either fails to perform or performs sub-optimally, or is defective. For example, the liquid valve operatively coupled to the at least one second opening, for example, a plurality of second openings, in the casing may be operable or operates to allow a liquid composition to pass into the hollow interior across the liquid valve, but not to allow air to pass out of the hollow interior across the liquid valve. In one example, the liquid valve may be operable or operates to substantially prevent air from passing out of the hollow interior across the liquid valve. With respect to the air valve operatively coupled to the at least one third opening, for example, a plurality of third openings, it may be operable or operates to allow air to pass out of the hollow interior, but not allow a liquid composition from passing into the hollow interior across the air valve. In one example, the air valve may be operable or operates to substantially prevent a liquid composition from passing into the hollow interior across the air valve.

The liquid-permeable element(s) or component(s) may comprise any suitable liquid-permeable structure, and all such structures are included within the scope of the present invention. In one example, the liquid-permeable element or component comprises a membrane or membrane component, such as, without limitation, filter members or filter media, for example, porous or semi-permeable membrane members or components.

The membrane component, for example, porous or semi-permeable membrane, of the apparatus of the invention may be made of any suitable material that permits the desired, preferably sustained, release of the additive composition into the liquid composition, particularly when the casing is in contact with the liquid composition. The membrane may be made of a liquid-insoluble material, for example, having irregularly-sized channels or discrete-sized pores therein. As used herein, a “porous” membrane refers generally to membranes having pores in a substantially discrete size range, such as a wire screen or filter media, for example, filter paper and the like. As used herein, a “semi permeable” membrane refers to a continuous medium, which does not have pores in a discrete size range, but instead preferably permits diffusion of molecules through narrow channels, the size of which may be difficult to measure.

The membrane component or member may be secured, for example, fixedly secured, to the casing, or to at least a portion of the casing, in any suitable manner. For example, the membrane may be adhered to the casing using an adhesive or glue; may be secured to the casing by press fitting or interference fitting the membrane to the casing; may be secured to the casing, for example, by co-molding the membrane with the casing or at least a portion of the casing; by welding, for example, sonically welding the membrane to the casing or at least a portion of the casing; and/or may be otherwise secured or fixedly secured to the casing.

The casing body may be structured to be refillable with additional additive composition, that is, an additive composition having the same chemical make-up or a different chemical make-up relative to the additive composition previously in the hollow interior of the casing.

In one example, the container is structured to be not refillable with additional additive composition. For example, the casing of the container may be structured so that it cannot be opened, for example, for refilling, without destroying the casing, or at least the usefulness of the casing.

In another aspect, the invention is directed to methods for releasing an additive composition, for example, at a sustained, and/or substantially controlled, rate into a liquid composition, for example, an industrial liquid composition. The present methods may comprise placing a container as set forth herein in contact with a liquid composition, the additive composition being effective when released into the liquid composition to treat the liquid composition, thereby treating the liquid composition.

When the container is exposed to a liquid composition, the liquid composition may pass through the at least one second opening across the liquid valve operatively coupled to the at least one second opening to allow a liquid composition to pass into the hollow interior and may substantially prevent air from passing out of the hollow interior through the at least one second opening. In one example, the liquid composition comes in contact with a portion of the additive composition in the casing. The air valve, for example, operatively coupled to the at least one third opening, may allow air to pass out of the hollow interior and may be effective to substantially prevent a liquid composition from passing in to the hollow interior through the at least one third opening. Release, for example, fast, sustained and/or controlled release of the additive composition into the liquid composition may be obtained, for example, by diffusion of the additive composition mixed with the liquid composition through the liquid-permeable element and/or other mechanism.

The liquid composition, after release of the additive composition into the liquid composition using a container in accordance with the present invention may or may not be potable.

The containers of the present invention may be used in any application in which it is beneficial, or otherwise useful, to release one or more additive components into a liquid composition. Such applications may include, without limitation, cooling applications, such as treating recirculating cooling water in industrial and commercial cooling systems; fungi and/or algae control applications; potable water system applications; reverse osmosis system applications; swimming pool applications; spa and hot tub applications; down hole drilling applications; enhanced oil recovery applications; air washer, such as industrial air washer, system applications; aqueous and non-aqueous metal working fluid applications; food processing applications, e.g. food, such as egg and/or other food stuffs, washing applications; pulp and paper mill treating applications; brewery applications; industrial preservation applications; water treatment applications; fracturing fluid applications; industrial heavy equipment applications; humidification applications; spray water system applications; fire quench applications; open circulating coolant system applications; closed recirculating coolant system applications; process fluid system applications; heating fluid system applications and the like.

The container or containers of the present invention may be employed by placing the container or containers in an appropriate position, for example, in or near the system to be treated, so that additive composition or additive compositions from the container or containers is or are released into the liquid composition in the system.

U.S. Pat. No. 7,001,531 is directed to somewhat related subject matter. The disclosure of this U.S. Patent is incorporated in its entirety herein by reference.

In addition, the disclosure of each of U.S. patent Publication Ser. Nos. 09/030,4868, 09/029,4345, 09/029,4379 and 09/030,1968 is incorporated in its entirety by reference.

Various embodiments of the present invention are described in detail in the detailed description and additional disclosure below. Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any embodiment of the present invention.

Additional aspects and advantages of the present invention are set forth in the following description and claims, particularly when considered in conjunction with the accompanying drawings in which like parts bear like reference numerals.

### BRIEF DESCRIPTION OF THE DRAWINGS

FIG. 1 is a cross-sectional view of an additive composition container in accordance with the present invention.

FIG. 2A is a view taken along line 2A-2A of FIG. 1.

FIG. 2B is a view taken along line 2B-2B of FIG. 1.

FIG. 3 is a partial, schematic cross-sectional view of another example of an additive composition container in accordance with the present invention.

FIG. 4 is a partial, schematic cross-sectional view of further example of an additive composition container in accordance with the present invention.

### DETAILED DESCRIPTION OF THE INVENTION

The present invention is directed to containers for use in liquid systems, including, but not limited to, industrial liquid compositions or systems in or associated with industrial heavy equipment, including both stationary and mobile equipment; open circulating coolant or cooling systems, such as cooling towers and the like; humidification systems; spray water systems; fire quench tanks; storage tanks, such as fuel storage tanks and other storage tanks; industrial recirculating closed cooling systems; process fluid systems, such as cutting and/or other machining oil systems, heating fluid systems, for example, thermal heating fluid systems, and the like; swimming pools; spas; and the like. Other applications for the containers of the present invention are disclosed elsewhere herein.

Such containers may be effective in gradually, over a short or prolonged period of time, effectively, sustainably and/or otherwise controllably releasing, for example, under sustained and/or controlled conditions, additive compositions comprising one or more chemical additive components, for example and without limitation, corrosion inhibitors or corrosion control components, microbiocides, scale inhibitors or anti-scale components, dispersants, buffering agents, surfactants, anti-fouling agents and the like and mixtures thereof as described more fully elsewhere herein, into a liquid composition, for example, industrial liquid compositions, potable water, aqueous liquid compositions to be treated to be potable, other aqueous liquid compositions, non-aqueous liquid compositions and the like.

As used herein, the term “industrial liquid composition” means a liquid composition, such as a non-aqueous liquid composition or non-potable aqueous liquid composition, useful for or in use in at least one industrial application. Industrial aqueous liquids often are not potable, that is, for example and without limitation, are not intended for and are not suitable for bathing or direct consumption by humans, or for use in irrigating fruits and vegetables, or processing foods, to be consumed by humans. In contrast, potable aqueous liquids, for example, potable water, are intended for and are suitable for bathing or direct consumption or contact by humans, or for use in irrigating fruits and vegetables or processing foods, to be consumed by humans.

Representative liquid compositions include, but are not limited to, liquids, such as substantially aqueous liquids with or without one or more additives effective to benefit the liquid compositions and/or the system in which the liquid composition is employed; substantially non-aqueous liquids; and the like.

The size and shape of the containers or casings of the present invention are not of critical importance, provided that the size and shape of the particular container or casing used in a particular application is sufficient or appropriate to allow the container to be effective to perform its function, that is to provide for the desired release of an additive composition into the liquid composition, in the particular application. For example, and without limitation, the containers or casings may range in size, and in shape, for example, a bowl-shaped container, a cylindrical container, an elongated container, and containers or casings of other shapes. The container or casing may be, for example, about 1 inch or less to about 4 feet or more, or about 2 inches to about 3 feet, in depth or length, and about 1 inch or less to about 18 inches or more, for example, about 2 inches to about 12 inches, in diameter or width. For example, for a cylindrical or similarly shaped container or casing, a size of from about 1 inch or less or about 6 inches or about 2 feet to about 4 feet or more in length, and about 1 inch or less or 2 inches to about 6 inches or about 1 foot or more in diameter may be employed. The volume of the hollow interior of the casings of the containers of may be in a range of about 0.5 cubic inches or less to about 1500 cubic inches or more, or about 1 cubic inch to about 1000 cubic inches or about 5 cubic inches to about 500 cubic inches or about 5 cubic inches to about 100 cubic inches.

The containers may be placed so as to contact the liquid composition to be treated. For example, and without limitation, the container or containers may be placed in a conduit, or a sump or a pool or a skimmer, for example, of a swimming pool and the like in which a quantity or mass of liquid composition to be treated is located. The container or containers, for example, in cooling systems, may be placed in an open trough of flowing liquid composition. In other cases, one or more of the containers or casings may be placed in a larger outer casing, for example, cylinder or cylindrically shaped outer casing, through which the liquid composition is pumped, for example and without limitation, by a recirculation pump on a cooling tower. In still other cases, the containers may be placed in a sump or catch basin, for example, and without limitation, of a cooling tower or humidification system. The containers may be variously sized and shaped to facilitate placement in a system to allow for contact with the liquid composition to be treated and release of the additive composition into such liquid composition.

The liquid compositions may initially (that is prior to treatment in accordance with the present invention) include one or more additives that provide one or more benefits to the liquid composition and/or the system in which the liquid composition is employed. The liquid compositions which may be treated in accordance with the present invention include both aqueous compositions, that is compositions which include a major amount, such as at least about 50% or about 70% or about 80% by weight of water; and non-aqueous compositions, that is compositions which include less than about 50% or about 30% or about 10% by weight of water. The liquid composition may be substantially anhydrous, or anhydrous, for example, containing about 5% by weight or less of water. Optionally, the liquid compositions may contain one or more additives other than those being released by the apparatus of the present invention. These additives may include, but are not limited to, such additive or additives which is (are) conventionally used in the type of liquid composition in question.

In one aspect, the present invention is directed to additive composition containers, for example, for use in cooling or coolant systems, for example, cooling or cooling systems not associated with engines, such as internal combustion engines, other industrial systems or applications involving liquid compositions benefited or otherwise affected by treating with one or more additive components and the like. Such containers may be designed to provide effective release of an additive composition into a liquid composition.

Exemplary liquid compositions include, without limitation substantially aqueous liquids; liquids including water and at least one freezing point depressant, e.g., at least one glycol, such as ethylene glycol, propylene glycol and the like glycols; substantially non-aqueous liquids, e.g., liquids based substantially on one or more glycols (for example, containing at least about 50% by weight of one or more glycols); and the like. Substantially any aqueous liquid composition or any non-aqueous liquid composition which may be benefited or otherwise affected by the addition of one or more additive component may be treated using the present containers.

The liquid composition may also be susceptible to unwanted growth of one or more types and/or species of microorganisms. For example, and without limitation, included among such microorganisms are bacteria, fungi, viruses, spores, and the like and combinations thereof. Such microorganisms or microbes may be present in the environment in which the liquid composition is located and/or is employed. In addition, or alternatively, the liquid composition may be such that the additive composition in the present apparatus is effective to substantially prevent any significant growth of one or more particular microorganisms, for example and without limitation, one or more microorganisms that may be introduced into the liquid composition unintentionally or otherwise through human or natural intervention. In other words, the additive composition in the present apparatus may be employed to substantially prevent any microbial growth in the liquid composition, to control the growth of one or more microorganisms in the liquid composition and/or to reduce the population of one or more microorganisms in the liquid composition, for example, a liquid composition which is contaminated with an excessive population or amount of one or more microorganisms. Thus, the present apparatus may be used to substantially prevent microbial growth, to control microbial growth and/or to reduce microbial growth in a liquid composition.

Unless otherwise expressly noted to the contrary, each of the words “include”, “includes”, “included” and “including,” and the phrase “for example” and abbreviation “e.g.” as used herein in referring to one or more things or actions means that the reference is not limited to the one or more things or actions specifically referred to.

In one example, present containers comprise a casing, for example, a liquid-insoluble and liquid-impermeable casing, having or defining a substantially hollow interior. The casing has at least one first opening into the hollow interior, for example, located in an outermost wall of the casing. In one example, the casing includes only one first opening. As described further herein, at least one second opening, for example, only one second opening, into the hollow interior and at least one third opening into the hollow interior may be provided as well.

The casing may have any suitable shape and size, which are often chosen to be compatible with the particular application involved. The casing, for example, may have a generally cylindrical shape, a generally bowl shape or any of a large number of other shapes. The casing may have one or more curved and/or planar walls or it may have all curved or planar walls.

The at least one first, second and third openings in the casing may be provided at any location or locations in the casing. For example, such opening or openings may be located at the top and/or bottom and/or ends and/or side or sides of the casing, as desired. The choice of the location for the openings may be at least partially based on the particular application involved, and/or the ease and/or the cost of manufacturing the present additive composition containers and the like factors and may have at least some effect on the performance effectiveness of the containers.

In order to illustrate and describe the invention more clearly, cylindrically-shaped casings and bowl-shaped casings are emphasized herein. However, the present invention is not limited thereto and may be applicable to casings of other shapes. Containers including such other shaped casings are included within the scope of the present invention.

In one example, the casing may be cylindrical in shape, for example, having a first end and a second end. The casing may be provided with at least one first opening, for example at one of the first end or second end or in the side wall of the casing. The casing may be substantially bowl-shaped. For example, the bowl-shaped casing defines a hollow interior, a top, bottom and one or more side walls. The first opening or openings may be located in the top, bottom and/or one or more side walls.

An additive composition may be provided in the hollow interior of the casing. At least one liquid-permeable element may be provided at or near the at least one first opening of the casing. For example, a liquid-permeable element may be provided at or near such at least one first opening of the casing. In one example, such liquid-permeable element or elements are effective to provide for release of a portion of the additive composition into the liquid composition in contact with and/or external from the casing, for example, in a controlled and/or sustained manner over time, while retaining a balance of additive composition within the casing.

The casing and other liquid-impermeable components of the present containers may be made of any suitable material or materials of construction. The material or materials of construction of the containers may have no significant detrimental effect on the additive composition or the liquid composition being treated or on the performance of the present containers. Such materials of construction may be selected from metals, such as steel, aluminum, metal alloys and the like, polymeric materials and the like combinations thereof and mixtures thereof. In one embodiment, such materials of construction is selected from metals, polyvinyl chloride (PVC), polyethylene (high density and/or low density), polypropylene (PP), other polyolefins, nylon, polyethylene vinylacetate (EVA), polypropylene vinylacetate (PVA), polyesters, polyphenylene sulfide (PPS) and the like, combinations thereof and mixtures thereof.

In one example, the at least one liquid-permeable element or component of a present container, preferably comprising at least one liquid-permeable membrane, such as a porous or semi-permeable membrane, facilitates or permits contact of liquid composition with the additive composition provided within the casing. The membrane may optionally be accompanied, when desired, by at least one membrane retention member or two or more retention members, for example, an open mesh screen, woven cloth, support grid, for example, included on the casing, and the like, effective in retaining and/or supporting the membrane intact and/or in a substantially fixed position relative to, for example, within, the casing.

The liquid-permeable membrane, membrane component or membrane member, herein sometimes referred to as membrane, may be composed of a suitable liquid-insoluble material, preferably selected from polymeric materials, glasses, metals, combinations thereof and mixtures thereof. For example, suitable materials include, but are not limited to, glasses, polyamides, such as nylon and the like, cellulosic polymers, such as cellulose acetate and the like, polyesters, polyethylene vinylacetate (EVA), polypropylene vinylacetate (PVA), polyvinyl chloride (PVC), polyurethanes, stainless steel mesh, sintered metals (such as sintered metal discs and the like), metal membrane filters (such as silver membrane filters and the like) and the like, as well as combinations thereof and mixtures thereof. In one example, the membrane comprises a material selected from cellulose; cellulose salts, for example and without limitation, cellulose acetate, cellulose sulfate, cellulose phosphate, cellulose nitrate and the like and mixtures thereof; cellulose esters; polyesters; polyamides, glasses and the like and combinations thereof.

The membrane may be a material through which an additive composition can pass, for example, by diffusion (although not necessarily through pores), such as silicone rubber, polyethylene, polyvinylacetate, natural and synthetic rubbers, and other polymers and waxes, and combinations thereof and mixtures thereof. Such membranes are often referred to as semi-permeable membranes. In one example, a “semi-permeable membrane” refers to a continuous film of a material, for example and without limitation, a polymeric material, permeable to the liquid composition, which permits diffusion of molecules through microscopic channels. The pore size of such a semi-permeable membrane may not be easily measured and is typically less than about 0.2 microns.

In one example, the liquid-permeable membrane of the present invention comprises a porous membrane, for example, a microporous membrane, such as those membranes having an average pore size within the range of about 0.2 microns or about 1 micron or about 2 microns to about 30 microns or about 40 microns to about 300 microns or more. As referred to herein, a “membrane” may be a single layer or may include multiple plies. The thickness of the membrane may be in a range of about 0.1 mm or less to about 0.5 mm or about 1 mm or about 5 mm or about 10 mm or more, although other thicknesses may be effectively employed. Examples of membrane materials include metal wire meshes; polymers, such as polyamides, e.g., nylon and the like, other polymers disclosed elsewhere herein and the like, meshes; filter media; and the like; combinations thereof; and mixtures thereof. Useful membrane materials may include materials useful as filter media, reverse osmosis (RO) membranes and the like, combinations thereof and mixtures thereof. Examples of such materials include the filter media available from Whatman, Millipore, Alhstrom, Parker Hannifin, Sartorius, as well as from others.

The presence of and/or size of pores in the liquid-permeable membranes employed in accordance with the present invention may not be the controlling factor in determining the rate of release of the additive composition into the liquid composition. Other factors which may be important, or at least have an effect, in determining the rate of release of additive composition into the liquid composition include, but are not limited to, the membrane material of construction, the physical dimensions (for example, thickness, volume and the like) of the membrane, the presence and/or intensity (density) of the electrical charge, if any, on the membrane material, the additive composition being employed, the degree of hydrophilicity/hydrophobicity of the membrane material, the form of the additive composition, the velocity or rate of flow of liquid composition into the container and the like.

To illustrate, consider each of two membranes having the same physical dimensions is used in identical containers containing the same amount of the same additive composition in accordance with the present invention. Each container is used to release the additive composition from the container into water in an identical manner and the rate of release of the additive composition is measured. One membrane is formed of cellulose, an electrically charged material, having an average pore size of 20-25 microns. The other membrane is formed of electrically uncharged glass having an average pore size of only 5 microns. However, the glass membrane, having the smaller pores, is found to have a higher or increased additive composition release rate relative to the electrically charged cellulose membrane.

Thus, a number of factors may be considered in choosing or selecting the membrane material to be used in accordance with the present invention to achieve the desired additive composition release rate. In one example, the material of construction of the membrane and the pore size of the membrane are selected to control the rate of release of the additive composition into the liquid composition.

In the event that a selected material is insufficiently rigid or stable under the conditions at which the present apparatus are used, for example and without limitation, the repeated hot-cold cycling of a cooling system or other system in which the apparatus is employed, a more thermoresistant material, such as one made of ceramic, glass and the like, combinations thereof and mixtures thereof, may be employed as a membrane material of construction.

The membrane may be secured to the casing so as to cover the at least one first opening in the casing, for example, so that no additive composition passes outside the casing without passing through the membrane. The membrane may be positioned in and/or directly adjacent the at least one first opening in the casing. In one example, the membrane may cover or substantially cover the at least one first opening in the casing. The membrane may be secured or fixedly secured to the casing, for example, adhering the membrane to the casing using an appropriate and compatible adhesive; mechanically securing the membrane to the casing, for example and without limitation, press fitting or interference fitting the membrane to the casing, such as by fastening the membrane between two parts of the casing which fastening is achieved by friction after the parts are brought toward each other; co-molding the membrane with the casing; welding, for example, sonically welding, the membrane to the casing; otherwise securing, for example, fixedly securing, the membrane to the casing; and the like.

In one example, the casing defines only one first opening in an outermost wall of the casing and the membrane is provided in or directly adjacent the only one first opening.

As noted above, in one example, the liquid-permeable element further comprises at least one retention member. For example, the membrane may be retained across the opening of the casing by one or more wire or mesh screens, for example, stainless steel mesh screens, grid work on the casing and the like. The membrane may be sandwiched between the casing and the retention member or between at least two retention members. The retention members may be structured, for example, so as to have a mesh size, to facilitate or permit additive composition from the casing to be passed, for example, by diffusion, into the liquid composition in contact with the container. For instance, the retainer member or members may have a mesh size in the range of about 10 to about 300 microns or about 500 microns or more. The retention member may be metal, e.g., stainless steel screening and/or woven cloth. The retention member or members may be made of the same material as the casing or of a different material relative to the material of construction of the casing.

The additive composition provided within a container of the invention may be effective when released into the liquid composition to control, for example substantially prevent, substantially maintain, or reduce, corrosion or unwanted microbial growth in the liquid composition. The additive composition may be provided in the form of a liquid, gel, paste or solid particles, for example, beads, tablets, pellets or grains, and the like, as well as mixtures thereof, within the casing.

An additive composition of the invention may further comprise a coating material that at least partially surrounds or encapsulates or coats the additive composition, as discussed elsewhere herein. Such coating material may be provided in order to at least assist in controlling, or to control, the release of additive composition, as desired. The coating material may be either liquid-soluble or liquid-insoluble. The coating on the additive composition may be such as to allow or permit at least some release of the additive composition from the casing into the liquid composition.

The additive composition of the present invention may include or may be located in a binder material and/or a matrix material, for example, a liquid-insoluble binder material and/or matrix material, such as a liquid-insoluble polymeric material. Examples of such binder materials and matrix materials include, without limitation, cellulose, liquid-insoluble cellulosic derivatives and the like and mixtures thereof. Other binder and matrix materials, for example, liquid-insoluble binder and matrix materials, useful with additive compositions, for example and without limitation, conventionally and/or commercially used with additive compositions may be employed in or with the additive composition of the present invention. The binder material and/or matrix material, if any, may be such as to allow or permit release of the additive composition from the casing into the liquid composition. The binder material and/or matrix material may be effective to at least assist in controlling, or to control, the release of the additive composition into the liquid composition. In one example, the additive composition may be present in the casing and no binder material and/or matrix material is employed.

In one example, as discussed herein, the liquid-permeable element or elements include a polymer-containing membrane, for example, a polymer-coated membrane, in order to achieve enhanced additive composition release control. In this example, the membrane, that is the membrane of the liquid-permeable element or elements, is suitably coated, impregnated or otherwise associated, for example, by spray coating, dip coating and the like, with a polymer material. Suitable polymer materials include, without limitation, liquid-insoluble materials which have no significant detrimental effect on the liquid compositions being treated, on the additive composition or on the performance of the present container. Examples of such coating materials include those listed by Mitchell et al U.S. Pat. No. 6,010,639, the disclosure of which is incorporated in its entirety herein by reference. In one example, the polymer material is polyethylene vinyl acetate copolymer. In addition, or alternatively, the present retention member(s) of the liquid-permeable element or elements may be coated, impregnated, or otherwise associated with a material, for example, a coolant-insoluble polymer material, such as those disclosed in Mitchell et al U.S. Pat. No. 6,010,639, to at least assist in controlling or to control, release of the additive composition from the casing, as desired. Other examples of useful coatings are disclosed in Blakemore et al U.S. Pat. No. 6,878,309, the disclosure of each of the patents identified herein is incorporated in its entirety herein by reference.

The container of the present invention may be filled with an additive composition through the opening or openings of the casing or otherwise.

The containers of the invention, for example, the casings of the containers, may include one or more liquid-impermeable cap members or liquid-impermeable plugs, which may be detachable or removable from the casing or the remainder of the casing, for example, to facilitate filling the interior space of the casing with an additive composition.

In one example, containers of the present invention, for example, the casings of the present containers, further include at least one second opening, into the hollow interior and at least one third opening into the hollow interior. The containers may further comprise a liquid valve operatively coupled to the at least one second opening, and an air valve, structured similarly to or different from the liquid valve, operatively coupled to the at least one third opening. These second and third openings and the liquid valve and the air valve may be positioned to independently allow a liquid composition to pass into the hollow opening through the at least one second opening and to allow air to pass out of the hollow interior of the casing through the at least one third opening.

In one example, the liquid valve may be operable or operates, for example, automatically operates, to allow a liquid composition to enter into the hollow interior. In one example, the air valve is operable or operates, for example, automatically operates, to allow air to pass out of the hollow interior through the at least one third opening and to substantially prevent a liquid composition from passing out of the hollow interior through the at least one third opening. In one example, the air valve is operable or operates to substantially prevent a liquid composition from passing into the hollow interior through the at least one third opening, while allowing air to flow out of the hollow interior through the at least one third opening.

In this example, the air valve coupled to the at least one third opening is effective to allow gaseous material, such as air or other gas, present in the hollow interior to escape through the at least one third opening across the air valve opening or openings. Liquid, e.g., liquid water, may be allowed to enter the hollow interior through the at least one second opening and across the liquid valve, during the period in which liquid initially fills the hollow interior. The escape of anything else, that is air or other gaseous material originally contained in the hollow interior, may occur through the structure coupled to the at least one third opening and not through or across the liquid valve associated with the at least one second opening.

Such containers are very useful in applications in which a liquid composition, such as an aqueous-based liquid, liquid water and the like, is to be passed into the hollow interior of the container to facilitate effective release of the additive composition into the liquid composition external from and/or in contact with the casing. In other words, the at least one second opening and at least one third opening and liquid valve and air valve operatively coupled to them, as described herein, may facilitate allowing and/or may be effective in allowing air to leave the hollow interior through the at least one third opening while a liquid, such as described herein, enters the hollow interior through the at least one second opening.

Any suitable valves may be employed in accordance with the present invention depending on the functions to be performed. Such valves may be operable and effective at the conditions at which the container is used, and may be made of materials which are compatible, that is materials which do not cause or create or have any undue or significant detrimental effect on the container during storage or use or on the liquid composition being treated. Examples of useful valves include, without limitation, duckbill valves, umbrella valves, ball valves, and the like and combinations thereof. In one example, valves to be used include a duckbill valve as the liquid valve, and an umbrella valve as the air valve. In another example, the valves to be used include an umbrella valve as the liquid valve and an umbrella valve as the air valve. Other valves or combinations of valves may be used. The valves may be adjustable so that the internal pressure within the hollow interior, for example, produced by liquid entering the hollow interior, may be controlled by adjusting the air valve to obtain a desired internal pressure within the hollow interior before the air valve is opened to allow air to leave the hollow interior through the at least one third opening in the casing.

One or more of a number of variables or factors may be adjusted to obtain a desired performance of a container in accordance with the present invention. For example, a desired additive composition release rate may be obtained by appropriate selection of one or more of: the number and type of membrane layers; membrane composition; membrane pore size, if any; the presence, type and amount, if any, of polymer associated with, e.g., coated, on the membrane; and the presence, type and amount, if any, of the coating on the additive composition. The rate of release may be influenced by one or more of the number and size of openings in the casing, the velocity or rate of inflow of the liquid composition into the container though the at least one second opening, the rate of outflow of air in the container through the at least one third opening, and the like factors. Other factors to be considered may include, among others, the type and form of the additive composition, the solubility of the additive composition in the liquid composition to be treated, the temperature of the liquid composition to be treated, and the velocity of the liquid composition to be treated and the like factors.

Further contemplated within the invention is a method for releasing an additive composition, for example, at a controlled rate and/or a sustained rate, into a liquid composition. In one example, the method comprises placing a container as described herein in contact with the liquid composition and releasing the additive composition into the liquid composition external from or of the container. The additive composition may be effective when released into the liquid composition to treat the liquid composition, for example, as described herein.

When the container is exposed to a liquid composition, the liquid composition may pass into the hollow interior through the at least one first opening and through the at least one liquid permeable element. In one example, at the same time, the liquid composition passes through the at least one second opening across the liquid valve into the hollow interior. During the time the liquid composition is passing into the hollow interior across the liquid valve, the flowrate or amount per unit time of the liquid composition passing across the liquid valve may be greater, for example, at least about 1.5 times or at least about 2 times or at least about 3 times or more as great as the flowrate of liquid composition passing through the at least one first opening and the at least one liquid permeable member into the hollow interior.

The flow of liquid composition through the at least one second opening across the liquid valve may be effective in facilitating release of the additive composition from the hollow interior through the at least one first opening into the liquid composition in contact with the container, for example, external from or of the casing.

The injection of liquid composition into the hollow interior across the liquid valve may be effective in enhancing the release of the additive composition from the hollow interior through the at least one further opening and/or is effective in reducing clogging or blocking of the at least one liquid permeable element with additive composition-containing material relative to an identical container without the liquid valve and at least one second opening.

At the same time the liquid composition is flowing into the hollow interior through the at least one second opening, air from inside the hollow interior may be passed out of the hollow interior through the at least one third opening across the air valve. Release of additive composition into the liquid composition may be obtained, for example, by diffusion of the additive composition mixed with the liquid composition, through the liquid-permeable element.

The liquid valve and the air valve may be structured differently from each other, for example, since each valve has a different function. In one example, the liquid valve and the air valve are the same type of valve, for example, umbrella valves, duckbill valves and the like. For example, the valves may be configured and/or positioned with reference to the hollow interior so that the liquid valve may be effective, as desired, to allow liquid to pass into the hollow interior across the liquid valve, and the air valve may be effective, as desired, to allow air, and other gas and/or vapor, to pass out of the hollow interior across the air valve. The liquid valve and air valve may be spaced apart from each other. The structure or configuration, and relative positioning of the two valves may be selected, as desired, to obtain the desired results. For example, the positioning of the liquid valve may be used to control the amount or level of liquid composition in the hollow interior. The configuration of the air valve may be selected to control the amount of air pressure (back pressure) present in the hollow interior. Because two separate valves are employed, their structures and/or sizes and/or configurations and/or positions may be selected independently, thus providing a greater degree of operating freedom relative to using a single valve to control the flow of liquid composition and air into and out of the hollow interior.

An additional advantage of using two separate valves is that such valves together may be less expensive and/or more cost effective than employing a single, for example, more complex or sophisticated, valve to perform the functions of both the liquid valve and the air valve.

The containers described herein provide for effective release, either fast or slow, for example, substantially complete and/or sustained and/or controlled release, of additive composition from the hollow interior into the liquid composition in contact with the container, for example, external of the casing. It is contemplated that, in some configurations, the liquid composition is permitted to flow around and encircle the casing containing the additive composition. However, even in these configurations, release of additive composition may be sustained and/or controlled, for example, by diffusion, for example, passive diffusion, rather than and/or by forced flow of liquid composition through the casing.

An additive composition for use in a container or cartridge of the invention may be provided as a liquid, gel, paste or as particles, for example, beads, tablets, pellets, grains, coated versions of these, and the like, as well as mixtures thereof. The particles may have a physical size large enough to prevent passage through the liquid-permeable components of the invention as described elsewhere herein.

As mentioned elsewhere herein, an additive composition comprising a chemical additive component for use with the present invention may be such as to be effective to serve some beneficial function within the liquid composition. In one example, the additive composition may include one or more of an anti-fouling agent, a pH buffering agent, a surface pitting inhibitor, a metal corrosion or hot surface corrosion inhibitor, a defoaming agent, a scale inhibitor, a hot surface deposition inhibitor, a dispersing agent, a surfactant, a microbiocide and the like, and mixtures thereof. One additive composition may be a combination of ammonium or alkali metal salts of nitrite, nitrate and molybdate ions, particularly a combination of sodium nitrite, sodium nitrate, and sodium molybdate. Additional additives include, for example, and without limitation, ammonium or alkali metal salts, for example, phosphate salts, borate salts, silicate salts, acidic salts, basic salts and the like and mixtures thereof. Further additives that may be used with the present invention are found in Mitchell et al U.S. Pat. No. 6,010,639, the disclosure of which is incorporated herein in its entirety by reference.

In one example, the additive composition comprises one or more of the following: (1) buffers to maintain the desired degree of acidity/alkalinity, e.g., a neutral or alkaline pH, including for example, alkali metal phosphates, borates and the like and mixtures thereof; (2) cavitation liner pitting inhibitors including alkali metal nitrites, molybdates and the like and mixtures thereof; (3) metal corrosion inhibitors and/or hot surface corrosion inhibitors including alkali metal nitrates and silicates, carboxylic acids, phosphonic acids, phosphonates, pyrophosphates, azoles, sulfonic acids, mercaptobenzothiazoles, metal dithiophosphates, metal dithiocarbonates, phenolic anti-oxidants including 4,4′-methylenebis (2,6-di-tertbutylphenol that is commercially available under the trademark Ethyl 702 by Ethyl Corporation) and the like and mixtures thereof; (4) defoaming agents including silicone defoamers, alcohols such as polyethoxylated glycol, polypropoxylated glycol, acetylenic glycols and the like and mixtures thereof; (5) hot surface deposition inhibitors and/or scale inhibitors including phosphate esters, phosphino carboxylic acids, polyacrylates, styrene-maleic anhydride copolymers, sulfonates and the like and mixtures thereof; (6) dispersants including non-ionic and/or anionic surfactants, e.g., phosphate esters, alkyl sulfonates, aryl sulfonates, alkylaryl sulfonates, linear alkyl benzene sulfonates, alkylphenols, ethoxylated alcohols and carboxylic esters, and the like and mixtures thereof; (7) organic acids including adipic acid, sebacic acid and the like and mixtures thereof; (8) anti-gel agents including those disclosed in Feldman et al U.S. Pat. No. 5,094,666, the disclosure of which is incorporated in its entirety herein by reference, copolymers of ethylene and vinyl esters of fatty acids with molecular weights of 500-50,000, tallow amine salts of phthalic anhydride, tallow amine salts of dithio benzoic acid, 4-hydroxy,3,5-di-t-butyl dithiobenzoic acid, ethylene vinylacetate copolymers and the like and mixtures thereof; and (9) microbiocides, preferably microbiocides used in cooling towers, and the like and mixtures thereof.

The additive compositions useful in the present invention may include one or more of the agents listed in the following Table 1. The possible functions of the agents identified in Table 1 are only intended to be exemplary, not limiting.

TABLE 1

| | | TYPICAL % |
|---|---|---|
| | | BY WT. IN |
| | | ADDITIVE |
| COMPONENT | POSSIBLE FUNCTION | COMPOSITION |
| Alkali metal or | corrosion inhibitor/ | 0-80 |
| Ammonium phosphates | buffering agent | |
| Alkali metal or | corrosion inhibitor/ | 0-80 |
| ammonium phosphonate | buffering agent | |
| Alkali metal or | corrosion inhibitor/ | 0-80 |
| ammonium pyrophosphate | buffering agent | |
| Alkali metal or | corrosion inhibitor/ | 0-80 |
| ammonium borate | buffering agent | |
| Alkali metal or | cavitation liner | 4-60 |
| ammonium nitrites | pitting/corrosion inhibitor | |
| Alkali metal or | cavitation liner | 4-60 |
| ammonium molybdates | pitting/corrosion inhibitor | |
| Alkali metal or | corrosion inhibitor | 4-60 |
| ammonium nitrates | | |
| Alkali metal or | corrosion inhibitor | 0-40 |
| ammonium silicates | | |
| Alkali metal or | corrosion inhibitor | 1-15 |
| ammonium salts of one | | |
| or more neutralized | | |
| dicarboxylic acids | | |
| Tolyltriazole | corrosion inhibitor | 1-15 |
| Dispersants (e.g. | deposition and scale | 0-15 |
| polyacrylic acid, | inhibitors | |
| phosphino carboxylic | | |
| acid, phosphate esters, | | |
| styrene-maleic anhydride | | |
| copolymers, polmaleic acid, | | |
| sulfonates and sulfonate | | |
| copolymers) | | |
| Defoamers (e.g. silicones, | foam inhibitor | 0-3 |
| polyethoxylated glycol, | | |
| polypropoxylated glycol, | | |
| acteylenic glycols) | | |

In one example, the additive composition includes nitrite compounds. The additive composition may include a mixture of nitrite compounds and molybdate compounds to maintain a minimum concentration level of about 800 ppm of nitrite or of nitrite and molybdate in the coolant in the cooling system, with the proviso that the minimum level of nitrite in the coolant system is often about 400 ppm. In one example, the additive composition includes a mixture of nitrite, nitrate and molybdate compounds. A useful additive composition may comprise one or more of nitrite, nitrate, phosphate, silicate, borate, molybdate, tolyltriazole, organic acid, scale inhibitor, surfactant and defoamer. Various other additive components and additive compositions are conventional and/or well known in the art. Such conventional/well known components/compositions may be used in the present containers and methods.

In one example, the additive composition is effective in controlling microbial growth in the liquid composition, and/or in the system in which the liquid composition is used or employed. As noted elsewhere herein, the additive composition may be effective in preventing unwanted microbial growth in the liquid composition and/or system, in reducing unwanted microbial growth, that is reducing the population of unwanted microbes, in the liquid composition and/or system, and/or in maintaining the population of unwanted microbes in the liquid composition and/or system at an acceptable or tolerable level. In short, the additive composition may have an effect on the population of unwanted microbes in a liquid composition and/or a system using or employing a liquid composition relative to the population of such microbes in an identical liquid composition and/or system without the additive composition being present. Accordingly, in one example, the additive composition comprises a microbiocide as substantially the only active additive component in the additive composition.

In one example, the additive composition is compatible with the container, and its component parts, in which it is placed, with the liquid composition to be treated, and with the system in which the liquid composition is used or employed. For example, and without limitation, the additive composition may be selected so as not to be unduly degraded or damaged by, and not to cause undue degradation or damage to, the container, the liquid composition to be treated and the system in which the liquid composition is used or employed.

The containers of the present invention may be placed in a liquid composition filter, either upstream or downstream of the filter medium, or it may be placed in the system in which the liquid composition is used or employed separate and apart (spaced apart) from the liquid composition filter, or it may be provided in a substantially fixed position in the liquid composition line, either upstream or downstream of a liquid composition filter. Release of an additive composition into the liquid composition may be governed, at least in part, by one or more of membrane pore size, membrane thickness, membrane composition, surface area of the membrane, viscosity of liquid additive composition, surface tension and membrane wetting ability of the additive composition and/or liquid composition, liquid composition system operating conditions, such as temperature, pressure and the like, and the like factors.

The invention will now be described with reference to certain examples, which illustrate but do not limit it.

### Example 1

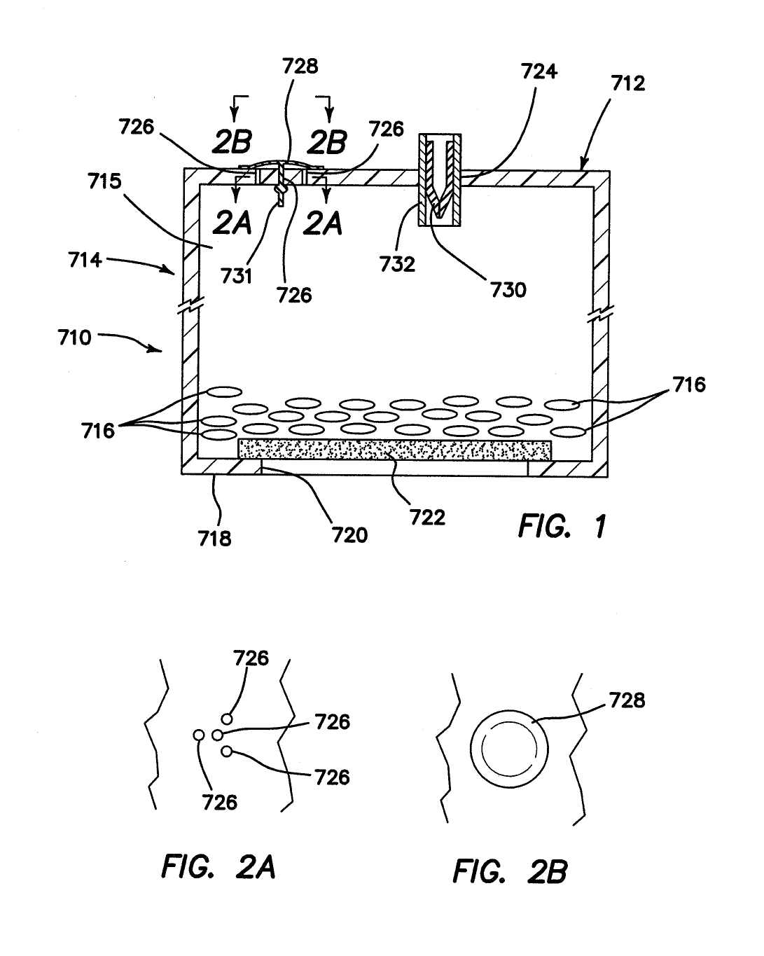

FIGS. 1, 2A and 2B show component parts of an additive composition container 710 in accordance with the present invention. Container 710 includes a casing or casing body 714. The casing body 714 includes or defines an interior hollow space or hollow interior 715 in which particles 716 of an additive composition are placed.

The casing body 714 may comprise or be made of any suitable material, for example, one or more polymeric materials. Examples of useful polymeric materials include, without limitation, polyolefins, polyamides (nylon), any suitable polymeric material, such as those which are conventional and/or well known and/or commercially available. Such polymeric materials may include polyolefins, such as polypropylene, polyethylene and the like.

The casing body 714 may also be molded using conventional and well known techniques. The casing body may be made using any suitable manufacturing process, for example, any conventional and/or well known process for making polymeric articles.

The bottom (as shown in FIG. 1) wall 718 of the casing body 714 is formed so as to have a first through opening or hole 720. A liquid permeable membrane member 722 is located so as to cover, e.g., substantially completely cover, first through opening 720.

In a particularly useful embodiment, membrane member 722 is molded into the casing body 714, for example, co-molded with the bottom wall 718. In this way, the membrane member 722 may be fixedly attached to the bottom wall 718 and completely covers first through opening 720.

The membrane member 722 may be made of any suitable material useful and effective in the application in which container 710 is to be used. Examples of useful materials from which the membrane member 722 may be produced include, without limitation, polyolefins, such as polypropylene, polyethylene, cellulose acetate, polyamides (nylon), polytetra-fluoroethylene (teflon) and the like. The membrane may be used in its native or untreated state or, if desired, may be further treated with one or more agents to impart one or more special or desired properties, for example, and without limitation a surface charge and the like, to the membrane to add in controlling release and/or to provide enhanced control of the release of the additive composition from the container.

The process by which the membrane member 722 is molded in or co-molded with the casing body 714 may be any conventional and/or well known molding or co-molding process. For example, the membrane member 722, in a form somewhat larger than the through hole 720, is placed in a mold with the center area of the membrane member being protected, so that the area that is protected is not covered by the polymeric material from which the casing body 714 is made, and may be exposed in the final product. A molten polymeric material is poured into the mold and the casing body 714 is formed with the outer peripheral edge of the membrane member 722 covered by or molded in the polymeric material of the casing body 714. Thus, for example, the outer edge of the membrane (not shown in FIG. 1), is located within the casing body 714 and is secured to the polymeric material of the casing body 714.

The upper wall 712 of the casing body 714 has a second through opening or hole 724 into which duckbill valve 730 is secured. Duckbill valve 730 includes a housing 732 which is fitted, for example friction fitted, to casing body 714. The duckbill valve 730 operates to allow liquid, e.g., water or aqueous liquid, to enter the hollow interior space 715.

The upper wall 712 of the casing body 714 also has a plurality of third through openings or holes 726, as shown in FIGS. 1 and 2A, spaced apart from second opening 724. These third through openings 726 may be produced in the process of molding the casing body 714 or by puncturing the top by mechanical and/or other force, (for example drilling or punching) for example, after the casing body 714 is molded or otherwise formed.

A valve, such as umbrella valve 728 shown in FIGS. 1 and 2B, operates to allow the majority of air to escape the hollow interior space 710 of the container in use, and further operates to substantially prevent the liquid to be treated from passing across the valve 728 either into or out of the hollow interior space. The umbrella valve 728, which includes a stem 731 extending through one of the third openings 726, may be selected with a desired, pre-selected back pressure to maintain a small amount or bubble of air in the hollow interior 715, for example, at the top of the hollow interior, when in use so that the only liquid passing into and out of the hollow interior passes through the membrane member 722. In this way, after a desired amount of liquid has entered the hollow interior 715 across the duckbill valve 102, the membrane member 722 is effective in controlling the release of the additive composition, for example, mixed with liquid composition from the container, for example, to the liquid composition external of casing body 714. The number, size, and arrangement of holes 726 are provided or selected to function with the umbrella valve 728 being employed. Different valves, even different umbrella valves, may employ one or more different openings or different arrangements of openings into the hollow interior.

One valve may be adequate to allow air to be released from the hollow interior space if the container is oriented vertically or substantially vertically, that is with the valve and hole or holes being located above the membrane member. However, if the orientation of the container is such that the valve openings and membrane are horizontal or substantially horizontal to each other, two or more umbrella valves 728 and/or duckbill valves 730 may be provided at two or more spaced apart locations so that one umbrella valve and one duckbill valve are always positioned to operate to allow sufficient air release from the hollow interior and sufficient liquid to enter the hollow interior to facilitate release of the additive composition from the container.

Umbrella valves suitable for use in the present systems are commercially available, for example, from Vernay Laboratories, Inc., having corporate headquarters located in Yellow Springs, Ohio.

Duckbill valve 730 in this example is a one-piece, molded elastomeric duckbill valve that is open inside to allow liquid composition to enter into hollow interior 715. Water passes to the hollow interior 715 through or across the duckbill valve 730. Once the hollow interior 715 is filled with the liquid composition to a desired extent and the system 710 is fully immersed in the liquid composition, pressure is equalized between hollow interior 715 and the exterior of casing body 714, by allowing air to flow out of umbrella valve 728.

Duckbill valves suitable for use in the present systems are commercially available, for example, from Vernay Laboratories, Inc., having corporate headquarters located in Yellow Springs, Ohio.

The exposed area of membrane member 722 allows a liquid, for example, an aqueous liquid, to pass through through hole 720 and the membrane member, and come in contact with the additive composition within the hollow interior of the casing body 714. After contacting the additive composition, the liquid passes out of the container 710, for example, through through hole 720 and membrane member 722, at which point the liquid includes sufficient additive composition to have been treated with the additive composition as intended and/or desired.

As shown in FIG. 1, the area of the membrane member 722 that is exposed is relatively large. This allows for more contact between the liquid and the additive composition in the hollow interior space of container 710 and increased release of the additive composition into the liquid composition. The size of the exposed membrane member may be selected, as desired, to achieve the desired level of treatment/treatments of the liquid composition being treated.

The sizes of the casing body 714, the exposed area of the membrane member 722, and the valves 728 and 730 may be selected to satisfy the requirements of the application in which the container 710 is to be used. For example, the size of the casing body 714 may be such as to include a hollow interior 715 having any suitable volume, for example, and without limitation, a volume in a range of about 1 cubic inch or less to about 1000 cubic inches or more, such as a volume in a range of about 2 cubic inches to about 600 cubic inches, or about 2 cubic inches to about 200 cubic inches, or about 2 cubic inches to about 80 cubic inches.

Specific sizes of the hollow interior 715 of the casing body 714 include, but are not limited to, about 2 ounces, about 8 ounces, and about 16 ounces and about 32 ounces. Containers in accordance with the present invention may have any suitable size of hollow interior space, including sizes much larger than 32 ounces.

In one example, the container 712 shown in FIGS. 1, 2A and 2B can may be used by placing a scale inhibitor or anti-scaling agent, such as polyacrylic acid, in the interior hollow space of the casing body 714. The container may then be used in a misting or mister system in which a stream of water is provided and is formed into a mist (fine liquid, e.g. water, droplets in air) for cooling or other purposes, for example, to be used to cool home air conditioners and increase their efficiency. In this particular application, the size of the interior hollow space of casing body 714 may be about 2 ounces (fluid ounces). This size of apparatus or container may be referred to as a “2 ounce bottle”.

Substantially the same apparatus may be provided in about 16 ounce (about 16 fluid ounce) and about 32 ounce (about 32 fluid ounce) bottle, or interior hollow space size of the casing body 714, for use with large misting or mister systems, such as those systems used, for example, in amusement parks and sports venues. Such large bottles or containers may require a lid or cap which provides additional support for the exposed area of the membrane, since a large membrane surface may be, and often is, exposed in such relatively large containers. Such supported membrane members are discussed hereinafter.

The umbrella valve 728 employed may be the same regardless of the size of the container, for example, whether the volume of the hollow interior of the casing body 714 is about 4 cubic inches (about 2 fluid ounces) or about 64 cubic inches (about 32 fluid ounces). A larger valve may be employed with a larger container (larger hollow interior space of casing body 714). Alternately, multiple valves, for example, two or more of the same valves, may be used with larger containers. Using the same valves regardless of container size advantageously reduces parts inventory and avoids manufacturing mistakes, for example, using the wrong valve.

A larger container 710, for example, having a hollow interior space more than about 4 cubic inches or about 10 cubic inches, may be employed to feed one or more additives, such as microbiocides, anti-scaling agents, corrosion inhibitors (corrosion control components) and the like to liquid compositions for use in other types of cooling systems and/or in other applications.

In certain embodiments, the present containers, such as container 710, may be used to feed anti-scaling agents (scale inhibitors) corrosion inhibitors, anti-fouling agents and the like to reverse osmosis units, other process applications and the like. Also, the present containers, such as container 710, may be used to treat an aqueous liquid composition with an additive or additives to make the aqueous liquid composition potable or to maintain the aqueous liquid composition in a potable condition.

In use, the container 710 may be placed in a flowing liquid composition, or a sump or other similar region, for example, where the liquid composition to be treated is present or collects, of a system using the liquid composition to be treated. The container 710 is advantageously positioned so that the membrane member 722 is located below or at substantially the same level as the plurality of through openings 726. The preferred positioning is a vertical arrangement where the membrane member 722 is down and the umbrella valve 728 and duckbill valve 730 are at the top. Such positioning allows more effective entry of the liquid composition into the hollow interior, effective removal of air from the hollow interior space of a casing body 714, and more effective contact of the liquid composition with the additive composition within the hollow interior space of the casing body and more effective release of the treated liquid composition from the membrane member 722.

### Example 2

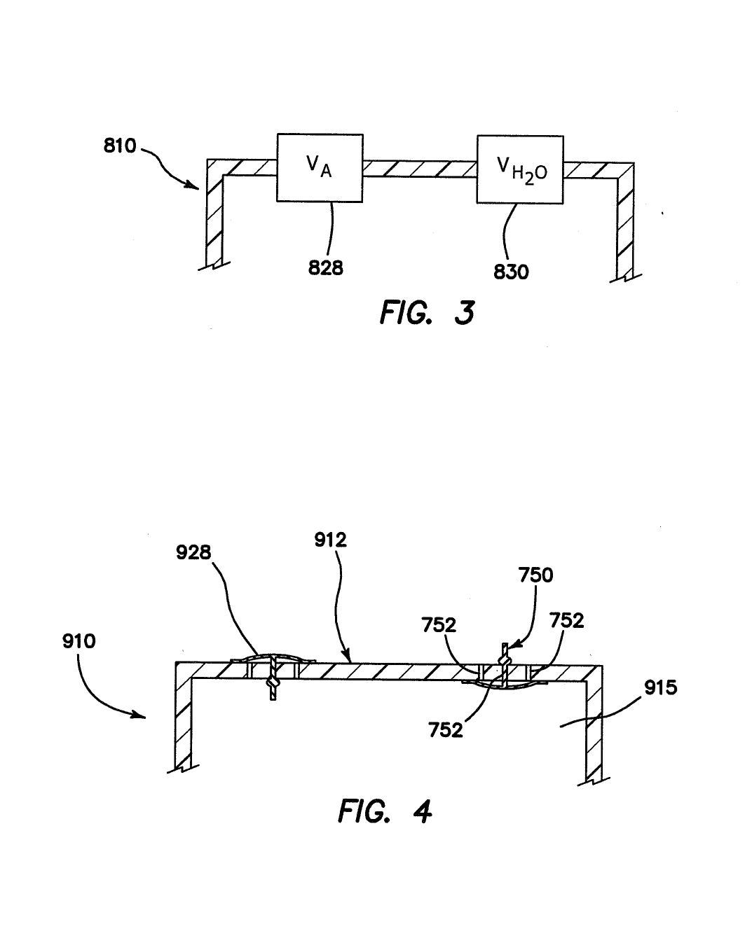

FIG. 3 is a partial view of a container 810 which, except as expressly set forth herein, is substantially similar to container 710. Elements of container 810 which correspond to elements of container 710 are identified with the same reference numeral as shown in FIGS. 1, 2A and 2B increased by 100.

FIG. 3 illustrate that container 810 is equipped with an air valve 828 of any suitable construction, and with a liquid valve 830 of any suitable construction.

Air valve 828 may be structured and configured to allow air and/or vapor to be released from the hollow interior 815, and may further operate to substantially prevent liquid from passing across the valve 828 either into or out of the hollow interior 815. Air valve 828 may be selected independently from liquid valve 830. Examples of valves which may be employed as umbrella valves, duckbill valves, ball valves and the like and combinations thereof.

Liquid valve 830 may be structured and configured to prevent or substantially prevent liquid from being passed out of the hollow interior 815 across liquid valve 830. Liquid valve 830 may be selected from umbrella valves, duckbill valves, ball valves, and the like and combinations thereof.

### Example 3

FIG. 4 is a partial view of a container 910 which, except as expressly set forth herein, is substantially similar to container 710. Elements of container 910 which correspond to elements of container 710 are identified with the same reference numeral as shown in FIGS. 1, 2A and 2B increased by 200.

The primary difference between container 910 and container 710 is that the duckbill valve (water valve 730 in FIG. 1) has been replaced by umbrella valve 750. In order to accommodate umbrella valve 750, a plurality, e.g., four, holes 752 are provided in the upper wall 912 of container 710. These holes may be as in FIG. 2A. Umbrella valve 750 is structured and configured to allow liquid to flow into the hollow interior across the liquid valve 750 and to prevent liquid from passing from the hollow interior 915 of container 910 across umbrella valve 750. Thus, as shown in FIG. 4, both the air valve 928 and the liquid valve 750 are umbrella valves, each of which is configured or positioned differently to perform a different function relative to the other umbrella valve.

A number of publications, patents and patent applications have been cited hereinabove. Each of the cited publications, patents and patent applications are incorporated herein by reference in their entireties.

Certain aspects and advantages of the present invention may be more clearly understood and/or appreciated with reference to the following commonly owned United States Patent Applications, the disclosure of each of which is being incorporated herein in its entirety by this specific reference: U.S. patent application Ser. No. 12/455,040 filed May 27, 2009, entitled “Devices and Methods for Controlled Release of Additive Composition”; U.S. patent application Ser. No. 12/455,041 filed May 26, 2009, entitled “Controlled Release Cooling Additive Compositions”; U.S. patent application Ser. No. 12/154,898 filed May 27, 2008, entitled “Controlled Release of Additive Compositions”; U.S. patent application Ser. No. 12/154,899 filed May 27, 2008, entitled “Controlled Release of Microbiocides” and U.S. patent application Ser. No. 12/154,900, filed May 27, 2008, entitled “Controlled Release Cooling Additive Composition”.

While the present invention has been described with respect of various specific examples and embodiments, it is to be understood that the invention is not limited thereto and that it may be variously practiced within the scope of the following claims.

What is claimed is:

1. A container for releasing an additive composition into a liquid composition, the container comprising:
a casing impermeable to a liquid composition, and defining a substantially hollow interior, at least one first opening into the hollow interior, at least one second opening into the hollow interior and at least one third opening into the hollow interior;
an additive composition comprising a chemical additive component located in the hollow interior of the casing;
at least one liquid permeable element provided at or near the at least one first opening of the casing and effective to provide for release of a portion of the additive composition into a liquid composition in contact with the casing;
a liquid valve operatively coupled to the at least one second opening and operable to allow a liquid composition to pass into the hollow interior across the liquid valve; and
an air valve operatively coupled to the at least one third opening and operable to allow air to pass out of the hollow interior across the air valve.

2. The container of claim 1, wherein the air valve and the liquid valve are structured differently from each other.

3. The container of claim 1, wherein the air valve and the liquid valve are structured similarly to each other.

4. The container of claim 1, wherein the liquid valve is operable to substantially prevent a liquid composition from passing out of the hollow interior across the liquid valve.

5. The container of claim 1, wherein the air valve is operable to substantially prevent air from passing into the hollow interior across the air valve.

6. The container of claim 1, wherein the liquid valve comprises a duckbill valve or umbrella valve.

7. The container of claim 1, wherein the air valve is a duckbill valve or umbrella valve.

8. The container of claim 1, wherein each of the air valve and the liquid valve is a duckbill valve.

9. The container of claim 1, wherein each of the air valve and the liquid valve is an umbrella valve.

10. The container of claim 1, wherein the additive composition comprises an active component selected from the group consisting of corrosion inhibitors, microbiocides, scale inhibitors (anti-scale components), dispersants, buffering agents, surfactants, anti-fouling agents, mixtures thereof and the like.

11. The container of claim 1, wherein at least a portion of the container is reusable.

12. The container of claim 1, wherein the at least one first opening, the at least one second opening and the at least one third opening are spaced apart from each other.

13. The container of claim 1, wherein the at least one liquid permeable element comprises a membrane component is fixedly secured to at least a portion of the casing.

14. The container of claim 1, wherein the casing includes a casing body and an end portion structured to be coupled to the casing body and to be removable from the casing body without destroying one of the end portion and the casing body.

15. The container of claim 1, wherein the hollow interior has a volume in a range of about 2 cubic inches or less to about 1000 cubic inches or more.

16. A method of treating a liquid composition, the method comprising placing the container of claim 1 in contact with a liquid composition, the additive composition being effective when released into the liquid composition to treat the liquid composition, thereby treating the liquid composition.

17. The method of claim 16, wherein the liquid composition is an aqueous liquid composition.

18. The method of claim 16, wherein the additive composition comprises an active component selected from the group consisting of corrosion inhibitors, microbiocides, scale inhibitors (anti-scale components), dispersants, buffering agents, surfactants, anti-fouling agents, mixtures thereof and the like.

19. The method of claim 16, wherein the additive composition comprises a scale inhibitor (anti-scale component), and the liquid composition is an aqueous liquid composition to be used in cooling application.

20. The method of claim 18, which further comprises using the liquid composition after treating in an application selected from the group consisting of cooling applications, fungi and/or algae control applications; potable water system treating applications; reverse osmosis system treating applications; swimming pools treating applications; spa and hot tub treating applications; down hole drilling treating applications; enhanced oil recovery treating applications; air washer, such as industrial air washer system treating application; aqueous and non-aqueous metal working fluid treating applications; food processing applications, e.g. food, such as egg and/or other food stuffs, washing applications; pulp and paper mill treating applications; brewery pasteurizer water treating applications; industrial preservation applications; publicly owned water treatment applications; fracturing fluid heating applications; and the like, industrial liquid compositions or systems in or associated with heavy equipment, including both stationary and mobile equipment, as well as open circulating coolant or cooling systems, such as cooling towers and the like; humidification systems; spray water systems; fire quench tanks; storage tanks, such as fuel storage tanks and other storage tanks; industrial recirculating closed cooling systems; process fluid systems, such as cutting and/or other machining oil systems, heating fluid systems, for example, thermal heating fluid systems, and the like; swimming pools; spas; and the like.
